(19) United States
(12) Patent Application Publication
(10) Pub. No.: US 2009/0262397 A1
(43) Pub. Date: Oct. 22, 2009

(54) METHOD AND APPARATUS FOR PRINT IMAGE DISTORTION COMPENSATION

(75) Inventor: Richard T. Horn, Claremont, CA (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/105,314

(22) Filed: Apr. 18, 2008

(51) Int. Cl. G06K 15/00

(52) U.S. Cl. 358/1.18

(57) ABSTRACT

Disclosed herein are tools allowing users to finely adjust the print image before actual printing to compensate for expected distortion. These tools will be available at the queue level and allow the user to apply adjustments to front side or back side of the pages independently. These tools utilize a feature within printers that allows “pre-ripping” of input documents into a set of separate files that include a calling program, a set of page images, and other files used by the system. These tools modify the calling postscript file to cause the needed image modifications. The exemplary embodiment provides the user GUI based tools at the queue level to manipulate the output image to compensate for repeatable distortion due to media movement during printing.

### BACKGROUND

The exemplary embodiment relates generally to image rendering devices used with image output terminals. More particularly, the exemplary embodiment is directed to a method and apparatus for print image distortion compensation.

Image rendering systems must be able to process increasingly more complex documents as well as support an increasing range of output media. Customers such as Print Fulfillment Companies are continuingly looking for new applications to sell by using new and unique print media. This print media can include special papers that are large, light weight, and/or of unusual composition. Because the print media desired may be very thin paper, this media exhibits stretching, shrinking, or skewing when passing through the print process. When these special papers are processed through standard printers the output image is often distorted due the combination of heat and pinch rollers pulling and pushing of the paper. Some of these applications require precise locations for the resultant print images for later mark sensing such as in forms or tests that use fill boxes or check mark detection. Even though the standard print devices enable shifting of the image position in two directions (up and down, left and right) there are no fine adjustments to compensate for skew, shrinkage, or stretching.

Often a Xerox printer customer requires precise placement of print images to support later input scanning by automated read devices. Examples include survey forms, tests, medicine evaluations by doctors, insurance forms, and response forms. As competition increases to support this “print for pay” market, customers are looking for new print media such as thinner paper, larger paper, or paper with an unusual surface texture. While the standard printers provide reliable placement of print image place on standard paper they sometimes have difficulty producing the same quality on such unusual stock. Errors such as image skewing, shrinking, or stretching can result from usual paper movement during printing because of heating and passing through various pinch rollers as it moves through the printer.

Some printers provide adjustments for image placement at the queue level with separate user input for horizontal (x) movement (10) or vertical (y) movement (20) for every page and for front and back pages (30, 40) if printing duplex, as shown in FIG. 1.

There are also some adjustments at the printer setup level for skew that are meant for fine-tuning average printer operation. These could be used with some difficulty by a trained support engineer for minor adjustments for long runs of unusual paper that exhibits a constant skew tendency.

A greater number of customers are now looking for more capability to not only adjust image skew, placement, and magnification but they want it at the queue level so that different jobs cab be run without extensive setup times between jobs.

Thus, the exemplary embodiments contemplate a new and improved method and apparatus that resolves the above-referenced difficulties and others.

### BRIEF DESCRIPTION

The exemplary embodiments disclosed herein provide the user tools to finely adjust the print image before actual printing to compensate for expected distortion. These tools will be available at the queue level and allow the user to apply adjustments to front side or back side of the pages independently. These tools utilize a feature within printers that allows “pre-ripping” of input documents into a set of separate files that include a calling program, a set of page images, and other files used by the system. These tools modify the calling postscript file to cause the needed image modifications. The exemplary embodiment provides the user GUI based tools at the queue level to manipulate the output image to compensate for repeatable distortion due to media movement during printing.

One disclosed feature of the embodiments is an image processing method. The method comprises: printing a test template a plurality of times; receiving image placement instructions for a print job at a controller; configuring a print queue to process the print job via the controller; creating a control file to control the subsequent re-printing with the desired adjustments; forwarding the control file to the print engine; and implementing the new positioning as the control file calls each image file for imaging.

Another disclosed feature of the embodiments is an image processing method. The image processing method comprises: printing a test template a plurality of times; receiving image placement instructions for a print job at a controller, wherein the image placement instructions comprise at least one of offset adjustments, skew adjustments, and magnification adjustments; configuring a print queue to process the print job via the controller; creating a control file to control the subsequent re-printing with the desired adjustments, wherein the control file comprises a page description language file; forwarding the control file to the print engine; implementing the new positioning as the control file calls each image file for imaging; and storing the print queue for future printing.

Yet another disclosed feature of the embodiments is an image processing apparatus comprising: a graphical user interface; at least one print engine for producing hard copy output from an input print job, wherein the print engine has access to a plurality of media types for the print job; a database for storing at least one of user profiles, work product for printing, a media library, and print job parameters; and a controller operative to: receive image placement instructions for the print job; configure a print queue to process the print job; create a control file to control the subsequent re-printing with the desired adjustments; and forward the control file to the print engine for processing.

### BRIEF DESCRIPTION OF THE DRAWINGS

FIG. 1 is a screen shot showing queue level input for basic image placement;

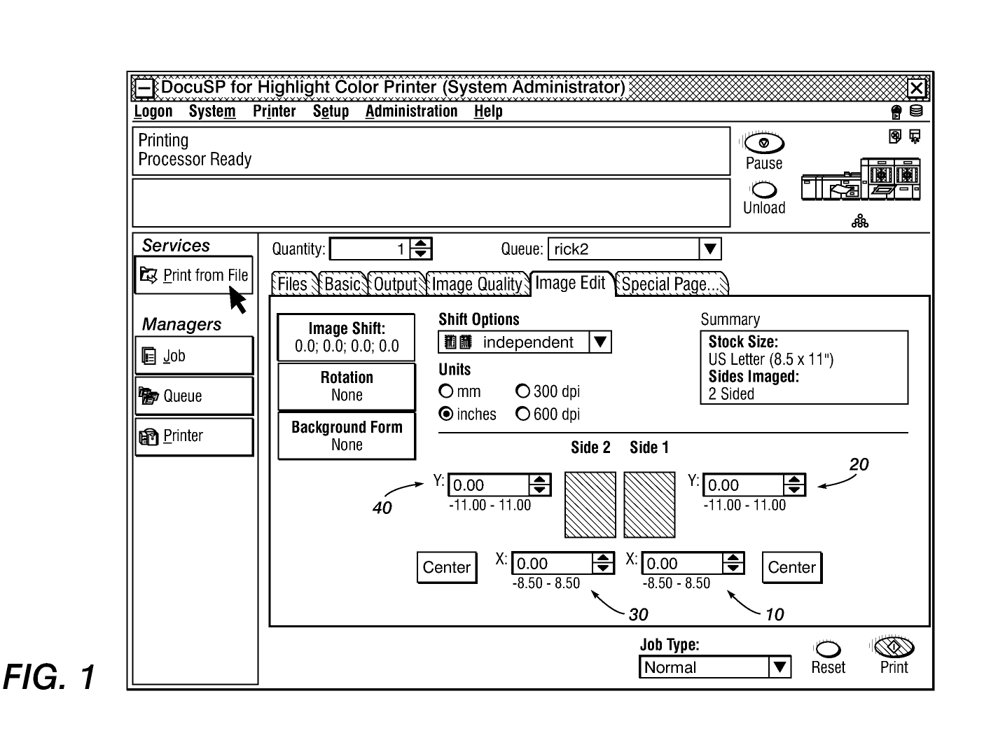

FIG. 2 is a block diagram of a printing system suitable for implementing aspects of the exemplary embodiments; and

FIG. 3 is a flow chart of an exemplary method of print image distortion compensation.

### DETAILED DESCRIPTION

Portions of the exemplary embodiments and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the exemplary embodiment are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The exemplary embodiment is not limited by these aspects of any given implementation.

In modern printing environments, different functional parts of the printing process are commonly divided amongst different subsystems. For example, print jobs can be stored or produced by a job source. A print job is a file or set of files that has been submitted to be printed. Jobs are typically identified by a unique number, and are assigned to a particular destination, usually a printer. Jobs can also have options associated with them such as media size, number of copies and priority. A job can be submitted to a digital front end (DFE) controller that processes the job and then passes it to a marking engine where it is actually printed. One of the processing functions performed by the DFE is known as raster image processing (RIP) in which a document description is transformed into an image that can be printed by a marking engine. An image is a two dimensional pattern of pixels that the marking engine can directly print whereas the document description can contain text and graphics.

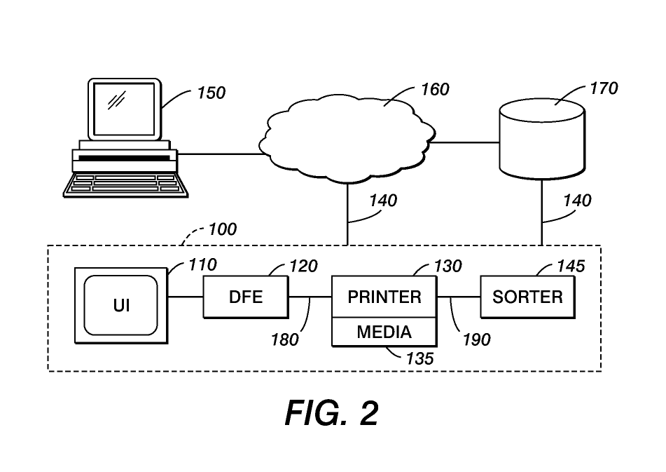

With reference now to FIG. 2, a printing system (or image rendering system) 100 suitable for implementing aspects of the exemplary embodiments is illustrated. The printing system 100 generally includes a graphical user interface (GUI) 110, a DFE controller 120, and at least one print engine 130. The print engine 130 has access to media 135 of various sizes and cost for a print job 140. The “print job” or “document” is normally a set of related sheets, usually one or more collated copy sets copied from a set of original print job sheets or electronic document page images, from a particular user, or otherwise related. For submission of a regular print job (or customer job) 140, digital data is generally sent to the printing system 100. A sorter 145 operates after a job is printed by the print engine 130 to manage arrangement of the hard copy output, including cutting functions. A user can access and operate the printing system 100 using the graphical user interface 110 or via a workstation 150. The workstation 150 communicates with the printing system 100 via a communications network 160. A user profile, a work product for printing, a media library, and various print job parameters can be stored in a database or memory 170 accessible by the workstation 150 or the printing system 100 via the network 160, or such data can be directly accessed via the printing system 100. One or more color sensors (not shown) may be embedded in the printer paper path, as known in the art.

The DFE 120 processes digital image data 140 received from the workstation 150 or memory 170 and converts the image data into binary print ready data 180 that is supplied to the print engine or marker 130. In response to the print ready data, the print engine 130 generates an output document 190 on suitable media. With continued reference to FIG. 2, the workstation 150, which may comprise a computer, a scanner or any similar or equivalent image input terminal (image source) and further includes any applications, drivers and operating system thereon, provides digital image data, which may comprise any combination of grayscale data, ASCII text characters, bitmap or bytemap images, graphic primitives, high level graphics or page description language (PDL) such as PostScript®, etc. The workstation 150 further includes a print driver or a similar tool for compiling job programming attributes (including color attributes) and assembling the attributes and image data into a print job 140.

The print driver provides an interface to enable a user to properly select and communicate job programming attributes to the DFE 120. Job programming attributes describe selected parameters by which a print job will be processed and can include parameters for page layout (e.g., size, orientation, duplex), color options (e.g., brightness, contrast, saturation) media type, finishing options (e.g., output tray, collate, staple, binding), etc. In addition to selecting parameters for the print job, the print driver can be used to set additional or alternate job attributes on a per page basis for selected pages. These special attributes to be used for selected pages within a job are often referred to as page exceptions. Similarly, the ability to set different attributes on a per page basis is sometimes referred to as page exception programming.

The use of print drivers to compile job programming attributes and page exceptions is well known in the field of digital printing. The DFE 120 will process the print job 140 according to the programmed job attributes and will process each page exception within the print job according to the page exception programming therein.

The DFE 120 may include one or more print queues (not shown) for receiving input data such as the print job 140. Each print queue is configured with a set of queue attributes. The queue attributes provide a set of processing parameters in the same manner as job attributes. The DFE 120 further includes a function which retrieves print jobs from the print queues and reconciles the attributes set at the workstation 150 with the attributes associated with the queue to which the job was submitted thereby generating a set of reconciled attributes. After reconciling the attributes, the print job 140 and reconciled attributes are passed to a decomposer (not shown). The decomposer receives the resolved print job and processes the received image data therein to produce print ready data 180 (which may be binary or contone data) that is supplied to a print engine or marker 130. In response to print ready data 180, the print engine 130 generates an output document 190 on suitable print media. The term “print engine” refers to a device for applying an image to print media. The print engine 130 is generally an electrophotographic engine; however, the print engine 130 may include such equivalent alternatives as ink jet, ionographic, thermal, etc. Print media generally refers to a usually flimsy physical sheet of paper, plastic, or other suitable physical print media substrate for images, whether precut or web fed.

A page description language (PDL) can be used to describe a document. A PDL can tell a DFE about the placement and appearance of text and images on a page. The appearance of a printable element, such as text, can include color, font, size, and other factors. A job, therefore, is often presented to the DFE as a PDL file. PostScript is an example of an early PDL. A file, such as a file stored in a computer, containing PostScript is a PDL file. Variable Data Intelligent Postscript Printware (VIPP®) is a more recent PDL. VIPP is a licensable language from Xerox that enables high performance output of variable-data PostScript documents. VIPP is discussed, for example, in U.S. Pat. No. 6,662,270, which is incorporated by reference herein.

As stated earlier, printers sometimes have difficulty producing the same quality on such usual stock. Errors such as image skewing, shrinking, or stretching can result from usual paper movement during printing because of heating and passing through various pinch rollers as it moves through the printer.

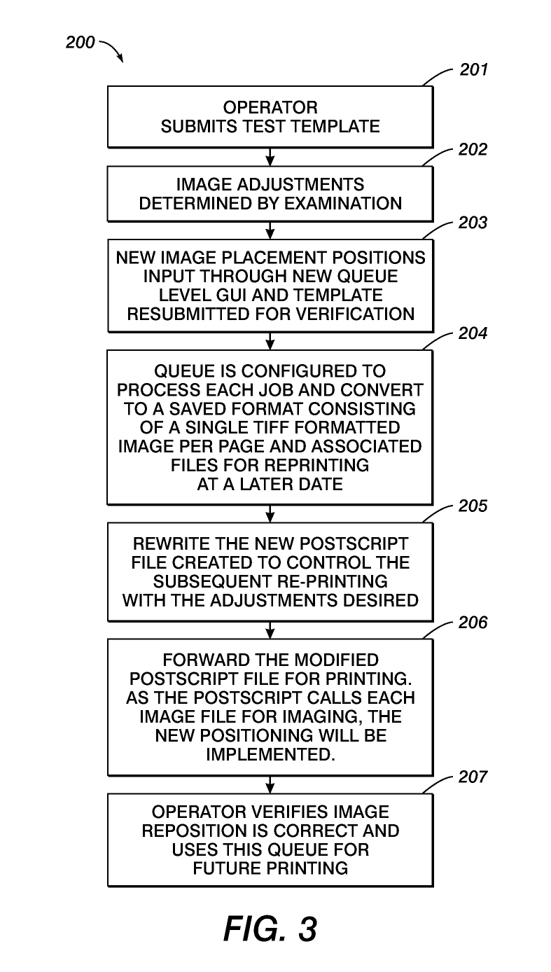

FIG. 3 illustrates an example workflow 200. When a new paper is proposed that exhibits a repeatable distortion during print processing, the operator will use a print job as a test template that will help the operator gauge what and how much distortion is being caused (201). For example, the operator may run 1,000 sheets and compare the first to the last sheet to verify a constant component of distortion.

Image adjustments are then determined by examination (202). New image placement positions (or instructions) are input by the operator through the new queue level GUI and received by the controller 120 (203). In this regard the operator may input additional offset adjustments, skew adjustments, and magnification. A print queue can be configured to process the job directly for printing, that is, the document input file may be directly decomposed into a format that is sent to the print engine 130. A print queue may also be configured to process each job and convert it to a saved format consisting of a single formatted image (e.g., TIFF) per page with associated control files for reprinting at a later date (204). One of these control files may be a new PDL (e.g., PostScript) file that is created to control the subsequent re-printing with the desired adjustments (205). The modified PDL file is then forwarded to the print engine 130 (206). As the PDL calls each image file for imaging, the new positioning will be implemented.

Finally, the operator verifies that the image repositioning is correct and saves this queue in the database 170 so that it may be used for future printing (207). This queue should be labeled by the operator in such a manner that it is readily apparent what paper, job type, and adjustment for which it is intended to be used. For example: airline_manual-13 lb-paper_{—}0.030_stretch comp_{—}2^{nd}_side.

An example of a modified calling PDL file, in this case a PostScript file, is shown below (changes underlined):

%%Page: 1 1
<<
/PageSize [612 791]
/MediaColor (white)
/MediaWeight 75.000000
/MediaType (Plain)
/Duplex false
>> setpagedevice
/pagelevel save def
[/Separation (Black)
[/CIEBasedABC <<
/RangeABC [0 0.9505 0 1 0 1.0890]
/RangeLMN [0 0.9505 0 1 0 1.0890]
/WhitePoint [0.9505 1 1.0890]
>>]
{ pop 0 0 0 }
] setcolorspace
1 setcolor
1.2 1.2 translate
30 rotate
1 1.25 scale
(Shrinkagetest.pdf.p00000001.tif) GetTiffH
showpage

Accordingly, as indicated above, the following new standard PostScript commands were added: Translate—move present origin to new location; Rotate—image is rotated about current origin; Scale—coordinate system is scaled in independent amounts for the x and y directions; and a Call for image which will be placed at the new location at the requested scale size. Similar standard PostScript commands may also be inserted to return the origin, rotation, and scale all to the original locations before the next page.

This exemplary embodiment will allow separate image manipulation for the front and back pages for duplex printing and will be modified in future versions to include the ability to select individual images out of a complete document on an exception page level.

The exemplary embodiment may also provide customers an opportunity to adjust for malformed images contained within their documents. Even if the paper media does not introduce distortions during printing the same tools will be able to correct for page image movement that was in the original document. For example, if the original document was scanned and one of the pages slipped during that process the exemplary embodiment will provide the customer additional tools to correct the mistake before printing and save the expense of recreating the complete document.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An image processing method comprising:
printing a test template a plurality of times;
receiving image placement instructions for a print job at a controller;
configuring a print queue to process the print job via the controller;
creating a control file to control the subsequent re-printing with the desired adjustments;
forwarding the control file to the print engine; and
implementing the new positioning as the control file calls each image file for imaging.

2. The method of claim 1, wherein the image placement instructions comprise at least one of offset adjustments, skew adjustments, and magnification adjustments.

3. The method of claim 1, wherein the print queue is configured such that the print job is directly decomposed into a format that is sent directly to a print engine for printing.

4. The method of claim 1, wherein the print queue is configured such that the print job is converted to a saved format consisting of a single formatted image per page with associated control files for reprinting at a later time.

5. The method of claim 1, further comprising:
storing the print queue for future printing.

6. The method of claim 1, wherein the control file comprises a page description language file.

7. The method of claim 6, wherein the page description language is a PostScript-based language.

8. An image processing method comprising:
printing a test template a plurality of times;
receiving image placement instructions for a print job at a controller, wherein the image placement instructions comprise at least one of offset adjustments, skew adjustments, and magnification adjustments;
configuring a print queue to process the print job via the controller;
creating a control file to control the subsequent re-printing with the desired adjustments, wherein the control file comprises a page description language file;
forwarding the control file to the print engine;
implementing the new positioning as the control file calls each image file for imaging; and
storing the print queue for future printing.

9. The method of claim 8, wherein the page description language is a PostScript-based language.

10. The method of claim 8, wherein the print queue is configured such that the print job is directly decomposed into a format that is sent directly to a print engine for printing.

11. The method of claim 8, wherein the print queue is configured such that the print job is converted to a saved format consisting of a single formatted image per page with associated control files for reprinting at a later time.

12. The method of claim 8, wherein the print engine comprises an electrophotographic engine.

13. An image processing apparatus comprising:
a graphical user interface;
at least one print engine for producing hard copy output from an input print job, wherein the print engine has access to a plurality of media types for the print job;
a database for storing at least one of user profiles, work product for printing, a media library, and print job parameters; and
a controller operative to:
receive image placement instructions for the print job;
configure a print queue to process the print job;
create a control file to control the subsequent re-printing with the desired adjustments;
forward the control file to the print engine for processing.

14. The apparatus of claim 13, wherein the image placement instructions comprise at least one of offset adjustments, skew adjustments, and magnification adjustments.

15. The apparatus of claim 13, wherein the print queue is configured such that the print job is directly decomposed into a format that is sent directly to a print engine for printing.

16. The apparatus of claim 13, wherein the print queue is configured such that the print job is converted to a saved format consisting of a single formatted image per page with associated control files for reprinting at a later time.

17. The apparatus of claim 13, wherein the database further stores the print queue for future printing.

18. The apparatus of claim 13, wherein the print engine comprises an electrophotographic engine.

19. The apparatus of claim 13, wherein the control file comprises a page description language file.

20. The apparatus of claim 19, wherein the page description language is a PostScript-based language.
